(19) United States
(12) Patent Application Publication
(10) Pub. No.: US 2026/0137580 A1
(43) Pub. Date: May 21, 2026

(54) QUICK-MOUNTING ROLLATOR DEVICE

(71) Applicant: Zhongshan QUNN Medical Equipment Co., Ltd, Zhongshan (CN)

(72) Inventor: Weiguo LIU, Zhongshan (CN)

(73) Assignee: Zhongshan QUNN Medical Equipment Co., Ltd, Zhongshan (CN)

(21) Appl. No.: 18/979,318

(22) Filed: Dec. 12, 2024

(30) Foreign Application Priority Data
Nov. 20, 2024 (CN) 2024228333531

(51) Int. Cl. A61H 3/04

(52) U.S. Cl. CPC A61H 3/04; A61H 2201/0107; A61H 2201/0161; A61H 2201/1253

(57) ABSTRACT

The present application relates to a quick-mounting rollator device, which is composed of three parts: a front wheel quick-mounting group, a rollator frame, and a rear wheel quick-mounting group. A front wheel fixing shaft is inserted into a rollator frame fixing base, and a clamping rod is clamped to the front wheel fixing shaft to form the front wheel quick-mounting group. The front wheel quick-mounting group is connected to a front end of the rollator frame, and the rear wheel quick-mounting group is connected to a rear end of the rollator frame. In the present application, according to a design of a filling component, effects of reducing a connection gap between a rollator wheel and the rollator frame and reducing a shake are met.

### CROSS-REFERENCE TO RELATED APPLICATIONS

The application claims priority to Chinese patent application No. 2024228333531, filed on Nov. 20, 2024, the entire contents of which are incorporated herein by reference.

### TECHNICAL FIELD

The present application relates to the technical field of rollator devices, and in particular, to a quick-mounting rollator device.

### BACKGROUND

With the increasing popularity of online shopping, in rollator-related technologies, a quick-mounting design is generally adopted to disassemble a rollator into a plurality of parts for packaging and transportation, for example, a rollator wheel is detached from a rollator frame. After purchasing the rollator, a user only needs to perform quick mounting and connection.

The quick-mounting design facilitates the packaging and transportation of the rollator, which adapts to the existing situation, and the mounting of the user is also quick and convenient enough.

However, due to the influence of the quick-mounting design, after the rollator wheel is mounted on the rollator frame, it is possible that the rollator wheel shakes on the rollator frame due to the influence of a gap, especially as time goes by, the shake becomes more serious, thereby resulting in looseness of a position of the rollator wheel, and even affecting the use experience of the user.

### SUMMARY

An embodiment of the present application aims to solve at least one of the above technical problems. A quick-mounting rollator device is provided to ensure that effects of improving fastening of a position of a rollator wheel and improving use experience of a user are met.

The quick-mounting rollator device provided in the embodiment of the present application adopts the following technical solutions:
A quick-mounting rollator device, composed of three parts:
a front wheel quick-mounting group, a rollator frame, and a rear wheel quick-mounting group, where
a front wheel fixing shaft is inserted into a rollator frame fixing base, and a clamping rod is clamped to the front wheel fixing shaft to form the front wheel quick-mounting group; and
the front wheel quick-mounting group is connected to a front end of the rollator frame, and the rear wheel quick-mounting group is connected to a rear end of the rollator frame.

Optionally, the rollator frame includes a rollator frame body and a fixing member, and the rollator frame body is provided with a first hole; the rear wheel quick-mounting group includes a filling component, a movable bracket, and a first rollator wheel; the first rollator wheel is connected to the movable bracket, and the filling component is mounted in the movable bracket; and the movable bracket is provided with a second hole, and a position of the filling component in the movable bracket corresponds to the second hole.

Further, the fixing member is provided with a thread, and the filling component is provided with a thread; and
the rear wheel quick-mounting group is connected to the rollator frame, a position of the first hole corresponds to a position of the second hole, and the fixing member penetrates through the first hole and the second hole to be connected to the filling component.

Further, the filling component includes a filling member and a pressing member, and the pressing member is located in the filling member; the filling member is provided with a third hole, and the pressing member is provided with a fourth hole; and a position of the pressing member corresponds to the third hole.

Further, the fourth hole is provided with a thread, and the fixing member penetrates through the first hole, the second hole, the third hole, and the fourth hole.

Optionally, the rear wheel quick-mounting group further includes a clamping block member and a first spring, and the rollator frame is further provided with a fifth hole.

Further, the rollator frame further includes a second spring, and the rollator frame body is further provided with a sixth hole; and the rollator frame fixing base is located in the rollator frame body, the second spring is located in the sixth hole, and the clamping rod is sleeved with the second spring and extends into the rollator frame fixing base.

Further, the front wheel quick-mounting group further includes a second rollator wheel, and the second rollator wheel is fixedly connected to the front wheel fixing shaft; and the front wheel fixing shaft is provided with an inclined surface and a first vertical surface, one edge of the inclined surface is connected to the first vertical surface, and the first vertical surface is provided with a seventh hole.

Further, the rollator frame fixing base is provided with a second vertical surface, and the second vertical surface can be provided with an eighth hole.

Optionally, the front wheel fixing shaft is further provided with a plane surface, and the other edge of the inclined surface is connected to the plane surface.

In conclusion, the present application has at least one beneficial technical effect as follows:
1. According to a design of the filling component, effects of reducing a connection gap between the rollator wheel and the rollator frame and reducing a shake are met.
2. According to a design of the rollator frame fixing base, effects of reducing the connecting gap between the rollator wheel and the rollator frame, reducing the shake, and improving the use experience of the user may also be achieved.

### BRIEF DESCRIPTION OF DRAWINGS

FIG. 1 is a schematic structural diagram 1 of a quick-mounting rollator device according to an embodiment of the present application;

FIG. 2 is a schematic fractured exploded view 1 of a quick-mounting rollator device according to an embodiment of the present application;

FIG. 3 is a schematic exploded view of a filling component according to an embodiment of the present application;

FIG. 4 is a schematic fractured sectional view 1 of a quick-mounting rollator device according to an embodiment of the present application;

FIG. 5 is a schematic fractured exploded view 2 of a quick-mounting rollator device according to an embodiment of the present application;

FIG. 6 is a schematic fractured sectional view 2 of a quick-mounting rollator device according to an embodiment of the present application;

FIG. 7 is a schematic fractured structural diagram of a rollator frame according to an embodiment of the present application;

FIG. 8 is a schematic structural diagram 2 of a quick-mounting rollator device according to an embodiment of the present application; and

FIG. 9 is a schematic structural diagram 3 of a quick-mounting rollator device according to an embodiment of the present application.

Reference numerals in the drawings: 1. rollator frame; 11. rollator frame body; 111. first hole; 112. fifth hole; 113. sixth hole; 12. fixing member; 13. clamping rod; 14. rollator frame fixing base; 141. second vertical surface; 1411. eighth hole; 15. second spring; 2. rear wheel quick-mounting group; 21. filling component; 211. filling member; 2111. third hole; 212. pressing member; 2121. fourth hole; 22. movable bracket; 221. second hole; 23. first rollator wheel; 24. clamping block member; 25. first spring; 3. front wheel quick-mounting group; 31. front wheel fixing shaft; 311. plane surface; 312. inclined surface; 313. first vertical surface; 3131. seventh hole; 32. second rollator wheel; 4. folding bracket; 5. container bracket.

### DETAILED DESCRIPTION OF THE EMBODIMENTS

The technical solutions in the embodiments of the present application are clearly and completely described below with reference to the accompanying drawings in the embodiments of the present application. Apparently, the described embodiments are merely some rather than all of the embodiments of the present application. All other embodiments obtained by a person skilled in the art based on the embodiments of the present application without creative efforts shall fall within the protection scope of the present application.

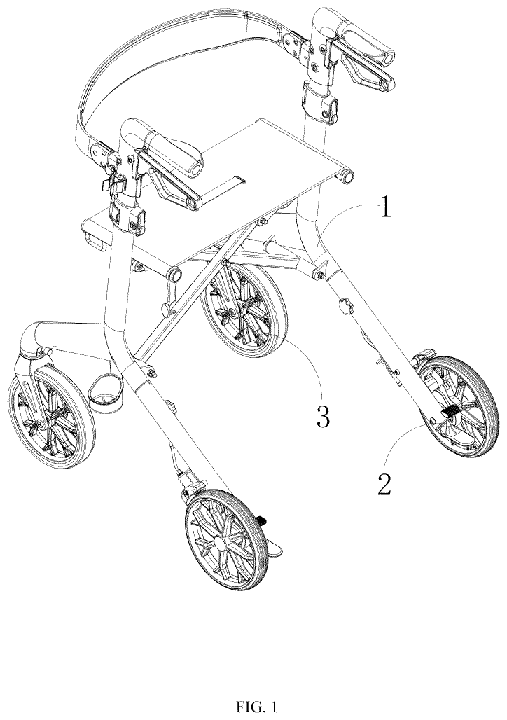

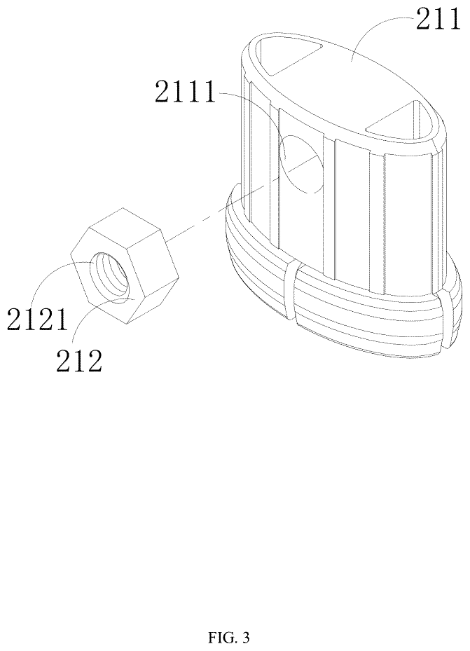

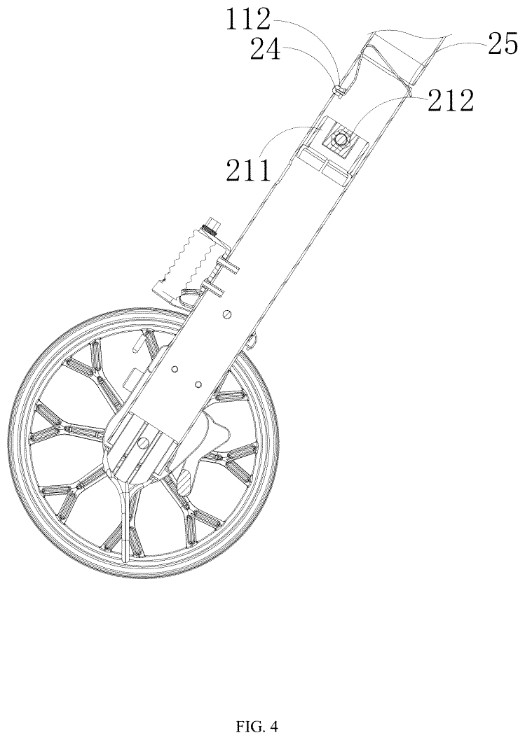

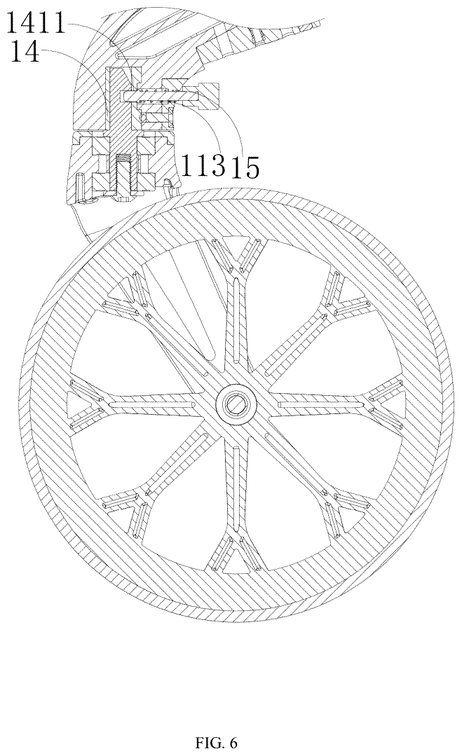

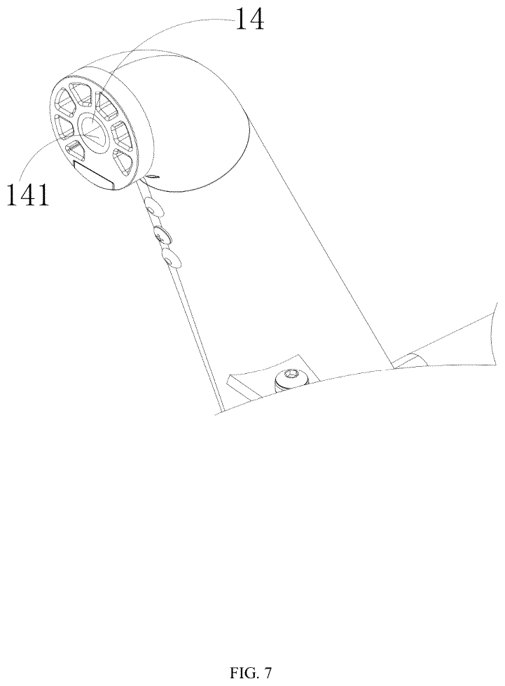

An embodiment of the present application discloses a quick-mounting rollator device. Referring to FIG. 1 to FIG. 7, the quick-mounting rollator device includes a rollator frame 1, a rear wheel quick-mounting group 2, and a front wheel quick-mounting group 3. The rear wheel quick-mounting group 2 is connected to the rollator frame 1, and the front wheel quick-mounting group 3 is connected to the rollator frame 1.

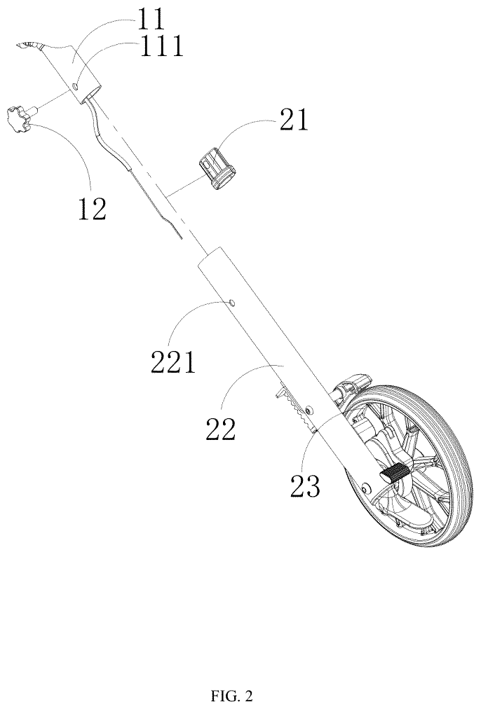

Further, with reference to FIG. 2 to FIG. 4, it may be understood that the rollator frame 1 may include a rollator frame body 11, and a fixing member 12, and the rollator frame body 11 is provided with a first hole 111. The rear wheel quick-mounting group 2 may include a filling component 21, a movable bracket 22, and a first rollator wheel 23. The first rollator wheel 23 is connected to the movable bracket 22, and the filling component 21 is mounted in the movable bracket 22. The movable bracket 22 is provided with a second hole 221, and a position of the filling component 21 in the movable bracket 22 corresponds to the second hole 221.

When the rollator frame 1 is connected to the rear wheel quick-mounting group 2, the rollator frame body 11 is connected to the movable bracket 22, a position of the first hole 111 corresponds to a position of the second hole 221, and the fixing member 12 penetrates through the first hole 111 and the second hole 221 to be connected to the filling component 21.

It may be understood that the fixing member 12 may be provided with a thread, the filling component 21 may be provided with a thread, the fixing member 12 may drive the filling component 21 to press the movable bracket 22, and the movable bracket 22 is tightly attached to the rollator frame body 11.

It may be understood that the filling component 21 includes a filling member 211 and a pressing member 212, and the pressing member 212 is located in the filling member 211. The filling member 211 is provided with a third hole 2111, and the pressing member 212 is provided with a fourth hole 2121. A specific position of the pressing member 212 located in the filling member 211 corresponds to the third hole 2111.

When the rollator frame 1 is connected to the rear wheel quick-mounting group 2, the rollator frame body 11 is connected to the movable bracket 22, the position of the first hole 111 corresponds to the position of the second hole 221, the fixing member 12 penetrates through the first hole 111, the second hole 221, the third hole 2111, and the fourth hole 2121, and the rollator frame 1 and the rear wheel quick-mounting group 2 are connected.

It may be understood that the fourth hole 2121 may be provided with a thread. The fixing member 12 penetrates through the fourth hole 2121, the pressing member 212 is driven to move by rotating the fixing member 12, and the pressing member 212 presses the filling member 211, then the filling component 21 presses the movable bracket 22, and finally, the movable bracket 22 is tightly attached to the rollator frame body 11, reducing a shake after the rollator frame 1 is connected to the rear wheel quick-mounting group 2.

It may be understood that the rear wheel quick-mounting group 2 further includes a clamping block member 24 and a first spring 25, and the rollator frame 1 is further provided with a fifth hole 112. When the rollator frame 1 is connected to the rear wheel quick-mounting group 2, the rollator frame body 11 is connected to the movable bracket 22, the clamping block member 24 is retracted after being blocked by the rollator frame body 11 until the clamping block member 24 corresponds to the fifth hole 112, and the clamping block member 24 extends out of the fifth hole 112 under the action of the first spring 25. At this time, the position of the first hole 111 corresponds to the position of the second hole 221.

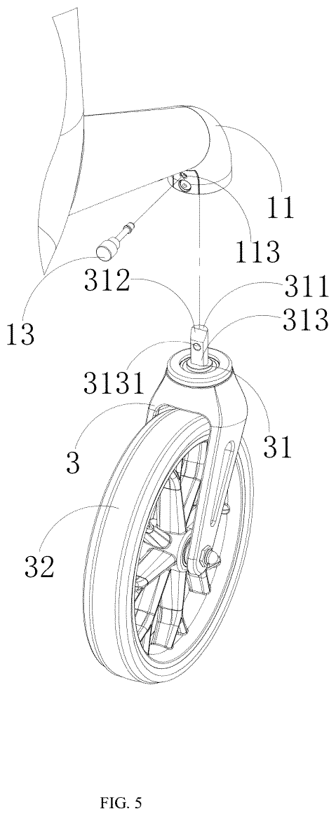

Further, with reference to FIG. 5 to FIG. 7, it may be understood that the rollator frame 1 may further include a clamping rod 13, a rollator frame fixing base 14, and a second spring 15, and the rollator frame body 11 is further provided with a sixth hole 113. The rollator frame fixing base 14 is located in the rollator frame body 11, the second spring 15 is located in the sixth hole 113, and the clamping rod 13 is sleeved with the second spring 15 and extends into the rollator frame fixing base 14.

The front wheel quick-mounting group 3 may include a front wheel fixing shaft 31 and a second rollator wheel 32, and the second rollator wheel 32 is fixedly connected to the front wheel fixing shaft 31. The front wheel fixing shaft 31 may be provided with a plane surface 311, an inclined surface 312, and a first vertical surface 313, one edge of the inclined surface 312 is connected to the first vertical surface 313, and the other edge thereof is connected to the plane surface 311. The first vertical surface 313 is provided with a seventh hole 3131. The rollator frame fixing base 14 may be provided with a second vertical surface 141, and the second vertical surface 141 may be provided with an eighth hole 1411.

The front wheel quick-mounting group 3 is connected to the rollator frame 1, the front wheel fixing shaft 31 corresponds to the rollator frame fixing base 14, the first vertical surface 313 corresponds to the second vertical surface 141, and the inclined surface 312 facilitates connecting the front wheel fixing shaft 31 to the rollator frame fixing base 14. At the same time, when entering the rollator frame fixing base 14, the inclined surface 312 squeezes the clamping rod 13 to be away from the rollator frame body 11 until the seventh hole 3131 corresponds to the clamping rod 13. Under the action of the second spring 15, the clamping rod 13 extends into the seventh hole 3131 through the eighth hole 1411. The clamping rod 13 fixes the front wheel quick-mounting group 3.

According to the second vertical surface 141, a direction of the front wheel quick-mounting group 3 when connected to the rollator frame 1 may be limited, and it may be ensured that the clamping rod 13 corresponds to the seventh hole 3131. According to the rollator frame fixing base 14, a gap between the front wheel quick-mounting group 3 and the rollator frame 1 is reduced, and the shake is reduced.

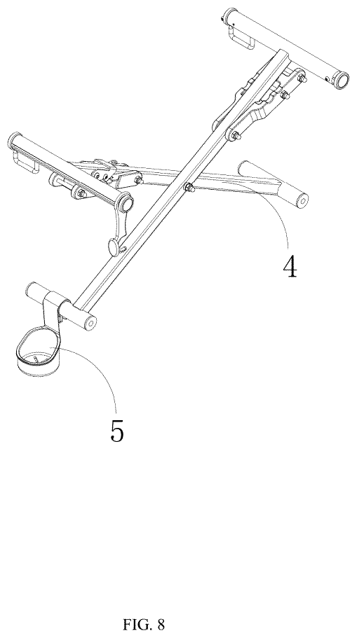

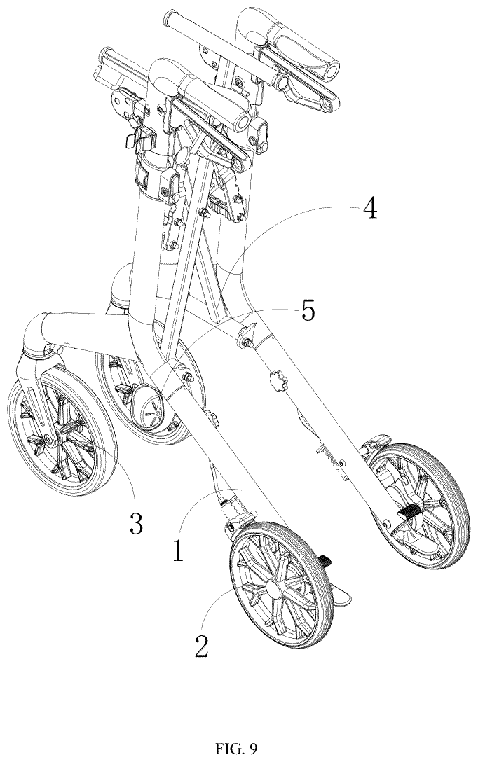

Further, with reference to FIG. 8 and FIG. 9, it may be understood that the quick-mounting rollator device may further include a folding bracket 4 and a container bracket 5. The folding bracket 4 is connected to the rollator frame 1, and the folding bracket 4 may facilitate folding the quick-mounting rollator device, to reduce space occupation. The container bracket 5 is connected to the folding bracket 4, and the container bracket 5 facilitates storing an object by a user.

It may be understood that the container bracket 5 is a preferred solution of the embodiment of the present application. Actually, the container bracket 5 may not be disposed, which is not specifically limited in the embodiment of the utility model.

In conclusion, the present application provides a quick-mounting rollator device. According to a design of the filling component, effects of reducing a connection gap between the rollator wheel and the rollator frame and reducing the shake are met; and according to a design of the rollator frame fixing base, effects of reducing the connecting gap between the rollator wheel and the rollator frame, reducing the shake, and improving use experience of the user may also be achieved.

The above descriptions are only implementations of the present application and do not limit the patent scope of the present application. The equivalent structure or the equivalent process transformation made by using the specification and the content of the accompanying drawings of the present application or directly or indirectly used in other related technical fields is included in the patent protection scope of the present application in the same way.

What is claimed is:

1. A quick-mounting rollator device, composed of three parts:
a front wheel quick-mounting group (3), a rollator frame (1), and a rear wheel quick-mounting group (2), wherein
a front wheel fixing shaft (31) is inserted into a rollator frame fixing base (14), and a clamping rod (13) is clamped to the front wheel fixing shaft (31) to form the front wheel quick-mounting group (3); and
the front wheel quick-mounting group (3) is connected to a front end of the rollator frame (1), and the rear wheel quick-mounting group (2) is connected to a rear end of the rollator frame (1).

2. The quick-mounting rollator device according to claim 1, wherein
the rollator frame (1) comprises a rollator frame body (11) and a fixing member (12), and the rollator frame body (11) is provided with a first hole (111); the rear wheel quick-mounting group (2) comprises a filling component (21), a movable bracket (22), and a first rollator wheel (23); the first rollator wheel (23) is connected to the movable bracket (22), and the filling component (21) is mounted in the movable bracket (22); and the movable bracket (22) is provided with a second hole (221), and a position of the filling component (21) in the movable bracket (22) corresponds to the second hole (221).

3. The quick-mounting rollator device according to claim 2, wherein
the fixing member (12) is provided with a thread, and the filling component (21) is provided with a thread; and
the rear wheel quick-mounting group (2) is connected to the rollator frame (1), a position of the first hole (111) corresponds to a position of the second hole (221), and the fixing member (12) penetrates through the first hole (111) and the second hole (221) to be connected to the filling component (21).

4. The quick-mounting rollator device according to claim 3, wherein
the filling component (21) comprises a filling member (211) and a pressing member (212), and the pressing member (212) is located in the filling member (211); the filling member (211) is provided with a third hole (2111), and the pressing member (212) is provided with a fourth hole (2121); and a position of the pressing member (212) corresponds to the third hole (2111).

5. The quick-mounting rollator device according to claim 4, wherein
the fourth hole (2121) is provided with a thread, and the fixing member (12) penetrates through the first hole (111), the second hole (221), the third hole (2111), and the fourth hole (2121).

6. The quick-mounting rollator device according to claim 1, wherein
the rear wheel quick-mounting group (2) further comprises a clamping block member (24) and a first spring (25), and the rollator frame (1) is further provided with a fifth hole (112).

7. The quick-mounting rollator device according to claim 6, wherein
the rollator frame (1) further comprises a second spring (15), and the rollator frame body (11) is further provided with a sixth hole (113); and the rollator frame fixing base (14) is located in the rollator frame body (11), the second spring (15) is located in the sixth hole (113), and the clamping rod (13) is sleeved with the second spring (15) and extends into the rollator frame fixing base (14).

8. The quick-mounting rollator device according to claim 7, wherein
the front wheel quick-mounting group (3) further comprises a second rollator wheel (32), and the second rollator wheel (32) is fixedly connected to the front wheel fixing shaft (31); and the front wheel fixing shaft (31) is provided with an inclined surface (312) and a first vertical surface (313), one edge of the inclined surface (312) is connected to the first vertical surface (313), and the first vertical surface (313) is provided with a seventh hole (3131).

9. The quick-mounting rollator device according to claim 8, wherein
the rollator frame fixing base (14) is provided with a second vertical surface (141), and the second vertical surface (141) can be provided with an eighth hole (1411).

10. The quick-mounting rollator device according to claim 1, wherein
the front wheel fixing shaft (31) is further provided with a plane surface (311), and the other edge of the inclined surface (312) is connected to the plane surface (311).
